(19) United States
(12) Patent Application Publication
(10) Pub. No.: US 2006/0279546 A1
(43) Pub. Date: Dec. 14, 2006

(54) Keyboard with surface for computer mouse operation and moveable numeric keypad

(76) Inventor: Daniel D. Karmazyn, Thornhill (CA)

Correspondence Address: Mirek A. Waraksa, Suite 1707, 145 Marlee Ave., Toronto, ON, M6B 3H3, CA

(21) Appl. No.: 11/149,533

(22) Filed: Jun. 10, 2005

(51) Int. Cl. G09G 5/00

(52) U.S. Cl. 345/168

(57) ABSTRACT

A keyboard device includes an alphanumeric keyboard and a numeric keypad moveable relative to the keyboard. The keyboard has structure defining a rolling or sliding surface for a mouse and also defining a storage compartment for the numeric keypad below the mouse rolling/sliding surface. In preferred form, the numeric keypad slides between a storage position within the keyboard and an external position in which the numeric keys are accessible. The keyboard and keypad are electrically coupled so that the key state of the keypad is accessible from within the keyboard itself. In preferred form, this permits a single processor within the keyboard to produce a key state signal corresponding to the combined key states of the alphanumeric keyboard and numeric keypad, which can be transmitted to an associated computer for appropriate processing.

### FIELD OF THE INVENTION

The invention relates generally to computer keyboards, and more specifically, to keyboards that provide a surface on which a computer mouse can be operated and also provide a movable numeric keypad that can be stored below that surface.

### BACKGROUND OF THE INVENTION

A computer keyboard has a core set of keys that conform to a QWERTY layout or otherwise provide basic punctuation and symbols. Other sets of keys have become standard and have contributed to the increasing size of a keyboard. For example, a computer keyboard commonly has a set of function keys labelled “F1” through “F12.” These are normally arranged in a straight line above the core set of alphanumeric keys and below an upper lengthwise edge of the keyboard. The software function triggered by any particular function key changes with the currently active software application. The advantage obtained is that a software application can assign a software function to a single function key rather than a core alphanumeric key in combination with one or more modifier keys, which adds to complexity of operation.

It is also common for a computer keyboard to have a distinct set of arrow keys, four in total. By convention, arrow keys are used in software applications that allow changes to character or line position in displayed text, those that allow creation and then movement of graphics on a display page, and those like spread sheets that allow focus to be moved between distinct cells. Similarly, a set of page navigation keys is commonly provided for use by software applications that generate or display scrolling electronic documents. These keys are commonly labelled “page up”, “page down”, “home” and “end” and usually include a “help” key that by convention accesses a software help file, and a forward delete key labelled “del” that deletes text character-by-character in a forward direction from the cursor position. Once again, a single key is available to trigger a software function that is similar, but not necessarily identical, in many software applications.

A numeric keypad is commonly built into the right side of a computer keyboard. The keypad usually groups keys labelled “0” through “9”, a decimal point “.”, and basic mathematical function keys such as “+”, “−”, “/” and “=”. Keys such as “enter”, “clear” and “num lock” are commonly included and used to trigger similar functions in software applications that perform mathematical operations. Other keys associated with the keyboard permit such data and function entry. However, there is an advantage to having all keys required to perform mathematical operations grouped for easy access in one location.

A computer keyboard often has a thin-film circuit board that cooperates with the various keys to indicate with open or closed circuit paths which keys are currently pressed. Each key is typically associated with a plastic cap bearing the character or symbol the key produces, and a bell-shaped elastomeric spring that supports the key cap and cooperates with the conductive traces on the thin film circuit board to indicate when the key has been pressed. A keyboard processor is coupled to the circuit to detect which keys are pressed and to produce a key state signal encoding the identify of all such keys and transmitting the key state signal via a keyboard output port to an associated computer for processing by the operating system and the current software application.

A computer's operating system now commonly updates the position and appearance of a screen cursor in response to displacement of a computer mouse. The system also allows the user to specify choices with “mouse clicks”; that is, it allows a user to select files and interact with the computer by pressing a mouse button while the screen cursor is positioned over a particular screen object, such as a desktop file icon, a menu item, a dialog item or the like. The mouse normally generates signals indicating differential changes in position, which, together with mouse clicks, must be continually reported to the operating system associated with the computer. To that end, the mouse may be wired directly to the computer, for example via a universal system bus, or may be coupled directly to the computer via a wireless link. The mouse may alternatively be coupled to the computer through the keyboard, also by wired or wireless connection, in which case differential changes in the position of the mouse or changes in the effective position indicated by a stationary roller mouse, together with mouse clicks, are relayed to the computer via the keyboard output port.

A significant problem with a conventional keyboard is that the user is often obliged to operate the mouse on a special pad adjacent to the keyboard or on a smooth and mildly adherent desk surface. A particular problem arises with pull-out keyboard trays associated with computer desks and furniture. The keyboard tray will typically have a length of about 21 inches while a conventional keyboard with the various sets of keys described above will have a typical length of about 19 inches, leaving inadequate room on the tray for operation of the mouse. To address this problem, the user is obliged to find an alternative location to place the mouse. This location is typically on the desk a considerable distance from the keyboard and requires the user to reach beyond the keyboard repeatedly to perform mouse operations. The result is an ergonomically incorrect arrangement that leads to muscle strain regardless whether the mouse is a stationary roller-ball or a moveable device.

### BRIEF SUMMARY OF THE INVENTION

In one aspect, the invention provides a keyboard device that attempts to conserve desk space and position a mouse for maximum ergonomic efficiency. The device includes an alphanumeric keyboard optionally fitted with sets of function keys, document navigation keys, and arrow keys, all labelled in accord with conventional practice. The device also includes a numeric keypad that is movable relative to the keyboard. The keyboard has structure defining a platform on which the mouse can operate smoothly (rolling or sliding) and defines a compartment below that surface in which the numeric keypad can be stored. Electrical connector means couple the alphanumeric keyboard and the numeric keypad so that any key state indicated by the keypad is accessible from within the keyboard as for conventional processing by a keyboard processor. The electrical connector means have sufficient length to accommodate movement of the numeric keypad between the storage compartment and an operative position in which a user can enter numeric data. The keypad is preferably mounted to the device for sliding movement between its storage and operative positions, and detent or stop means prevent displacement beyond the operative position.

One advantage is that the numeric keypad can be stored when not required. Also, the overall area required for the device together with an associated mouse is not increased over requirements for a conventional keyboard since the keypad is stored below the surface on which the mouse rolls or slides. Function keys may typically be oriented in a straight line inset from an upper lengthwise edge of the keyboard casing as in the prior art. To further reduce desk space requirements, document navigation keys and arrow keys may be oriented in two distinct groups between the mouse pad and the upper edge of the keyboard casing but laterally offset from one another. Also, the hand movement required from mouse to document navigation keys, QWERTY keys or arrow keys is minimized and quite natural, reducing the likelihood of repetitive muscle strain. As well, the proposed keyboard configuration allows the user to be physically centered in the QWERTY area of the keyboard thus reducing repetitive muscle strain caused by being off center as is the case with the conventional keyboard/mouse arrangement, the mouse pad being placed beside the keyboard on desk or tray.

In preferred form, the alphanumeric keyboard comprises a first casing with an upper surface, a first multiplicity of keys protruding from the upper surface, and a primary circuit board mounted in the casing and cooperating with the first keys in a conventional manner to indicate the key state of the keyboard. A processor is coupled to the primary circuit board to generate in a conventional manner a key state signal identifying which of the keys are pressed and to transmit the signal via an output port associated with the keyboard to an associated computer. The numeric keypad has a second casing with an upper surface, a second multiplicity of keys protruding from the upper surface of the second casing, and a secondary circuit board mounted in the second casing and cooperating in a conventional manner with the keys to indicate the key state of the numeric keypad. The electrical connector means couple the secondary circuit board associated with the keypad to the primary circuit board associated with the keyboard so that the processor generates and applies to the output port a master key state signal corresponding to the combined key states of the alphanumeric keyboard and the numeric keypad. In effect, the single keyboard circuit used in a conventional keyboard to identify the state of all keys, including those of a fully integrated, stationary numeric keypad, is divided into two distinct parts and housed in two distinct casings. These circuit boards are joined by electrical connector means, such as a ribbon cable, to function as one board requiring only one keyboard processor, and the electrical connector means have sufficient length that the numeric keypad can be displaced fully from its storage position to its operative position.

Other aspects of the invention will be apparent from a description below of preferred embodiments and will be more specifically defined in the appended claims.

### DESCRIPTION OF THE DRAWINGS

The invention will be better understood with reference to drawings in which:

FIG. 1 is a plan view of a keyboard device comprising an alphanumeric keyboard and a numeric keypad in a stored orientation;

FIG. 2 is a fragmented plan view of the keyboard device with its numeric keypad extended from its storage compartment;

FIG. 3 is a side elevation of the keyboard device;

FIG. 4 is a bottom view of other keyboard device; and,

FIG. 5 diagrammatically illustrates circuit boards associated with the keyboard device, including a primary circuit board associated with the alphanumeric keyboard and a secondary circuit board associated with the numeric keypad.

### DESCRIPTION OF PREFERRED EMBODIMENTS

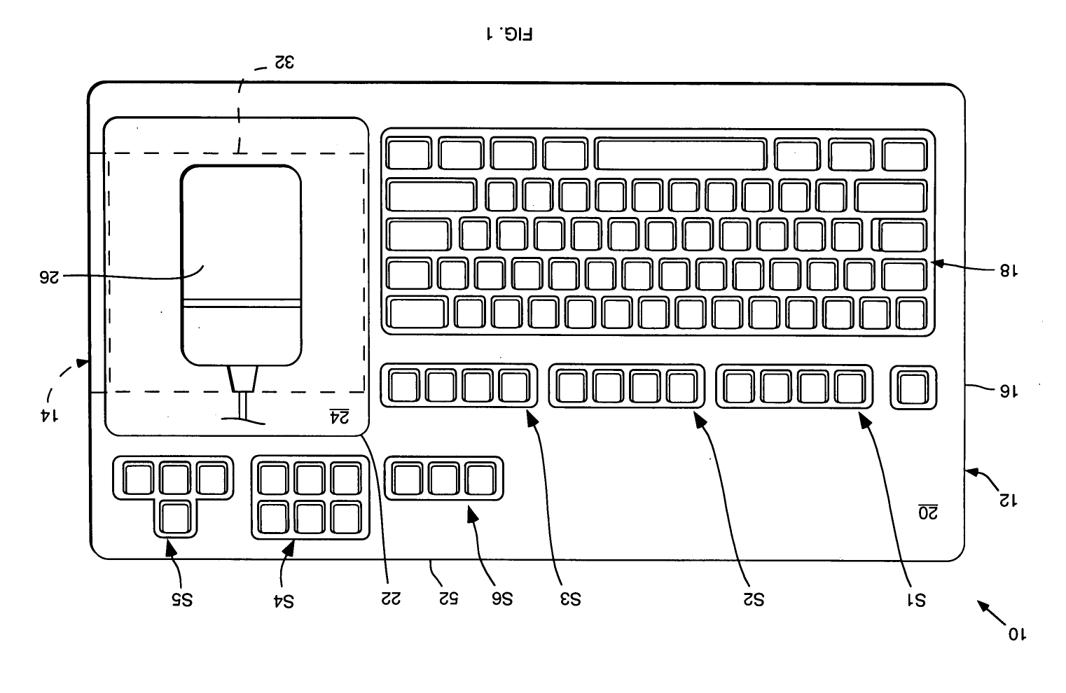

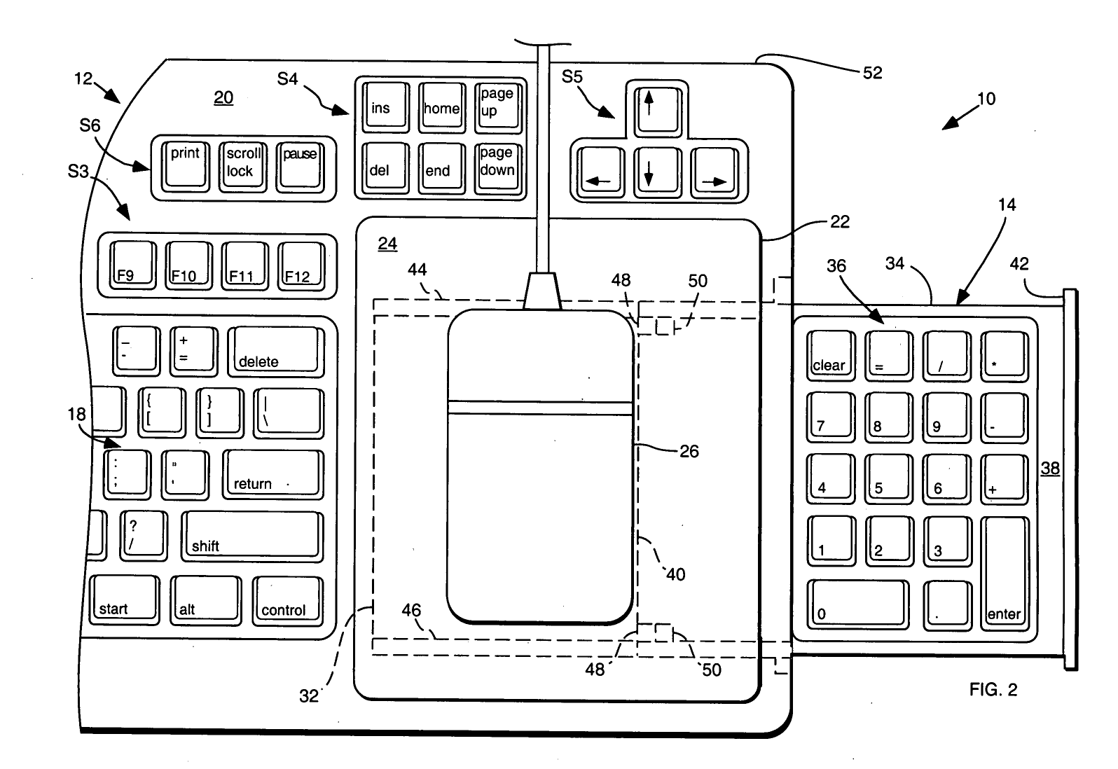

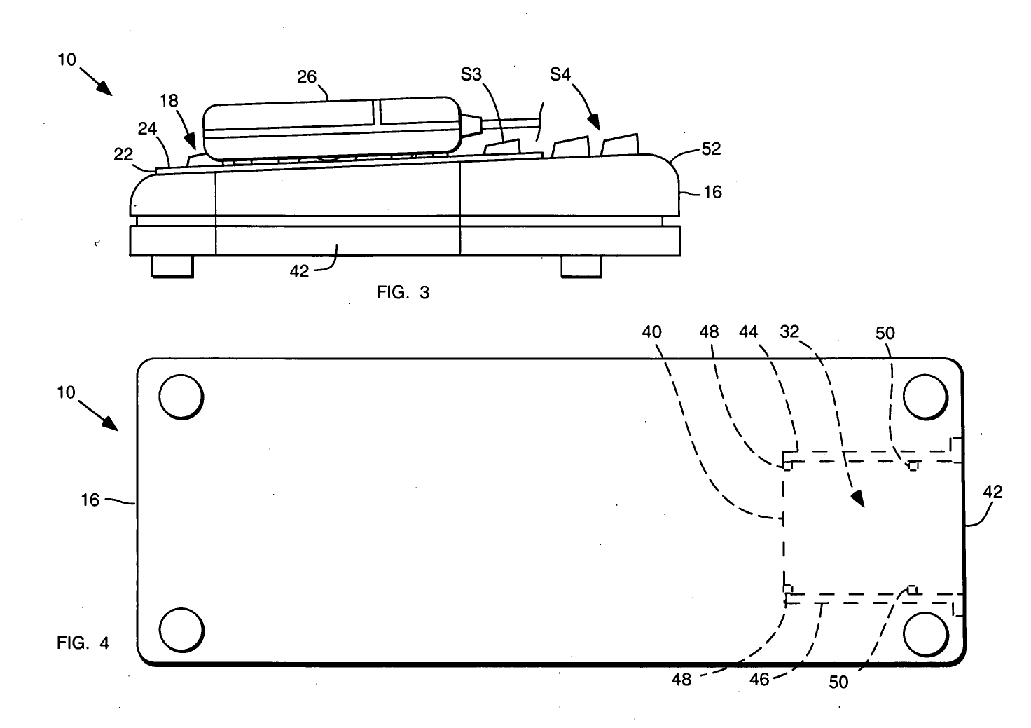

Reference is made to FIGS. 1 and 2 which illustrate a keyboard device 10 comprising an alphanumeric keyboard 12 and a numeric keypad 14 moveable relative to the keyboard 12. The keyboard 12 has a plastic case 16 constructed in upper and lower sections that are joined with screws, and basic keys 18 in a standard QWERTY layout that rise from the upper surface 20 of the case 16. In view of the scale of FIG. 1, the keys 18 are not labelled in FIG. 1.

A mouse pad 22 is adhered to the upper surface 20 of the case 16 where the numeric keypad 14 would normally be located. The mouse pad 22 effectively defines a platform that provides a smooth near-horizontal rolling surface 24 on which a mouse 26 can roll or slide. The case 16 also defines an internal compartment 32 beneath the mouse pad 22 and dimensioned to store the numeric keypad 14. As apparent in FIG. 2, where the keypad 14 is shown in its operative position removed from the compartment 32, the keypad 14 comprises a plastic case 34 in which keys 36 are mounted in a conventional manner and protrude from an upper surface 38 of the case 34. The keys 36 are devoted largely to mathematical operations and permit entry of digits “0” to “9” and a decimal place “.”, specification of mathematical operators such as plus “+”, minus “−”, multiplication “*” and division “/”, and specification of operations such as “clear”, “enter” and “=” (equals). The relative orientation of these keys 36 is conventional, and the manner in which operations involving numeric data and operators entered with the keypad 14 are executed either by operating system software or specific application software is well known and will not be described. The keypad 14 displaces horizontally between the positions shown in FIGS. 1 and 2. As apparent in FIGS. 2 and 4, the case 34 of the numeric keypad 14 has a lower plate 40 attached to an outer door 42. The plate 40 is received for sliding movement between a pair of parallel channels 44, 46 formed in the base of the keyboard case 16. A pair of moving stops 48 are fixed to an upper surface of the lower plate 40 adjacent an inner end of the plate 40. A pair of stationary stops 50 are fixed to the channeled members 44, 46 to engage the moving stops 48 and prevent the case 34 from sliding completely from the compartment 32 (unless the keyboard case 16 is completely disassembled). How the numeric keypad displaces between its stored and operative orientations is not a critical aspect of the invention, and technology associated with disk drives may be used.

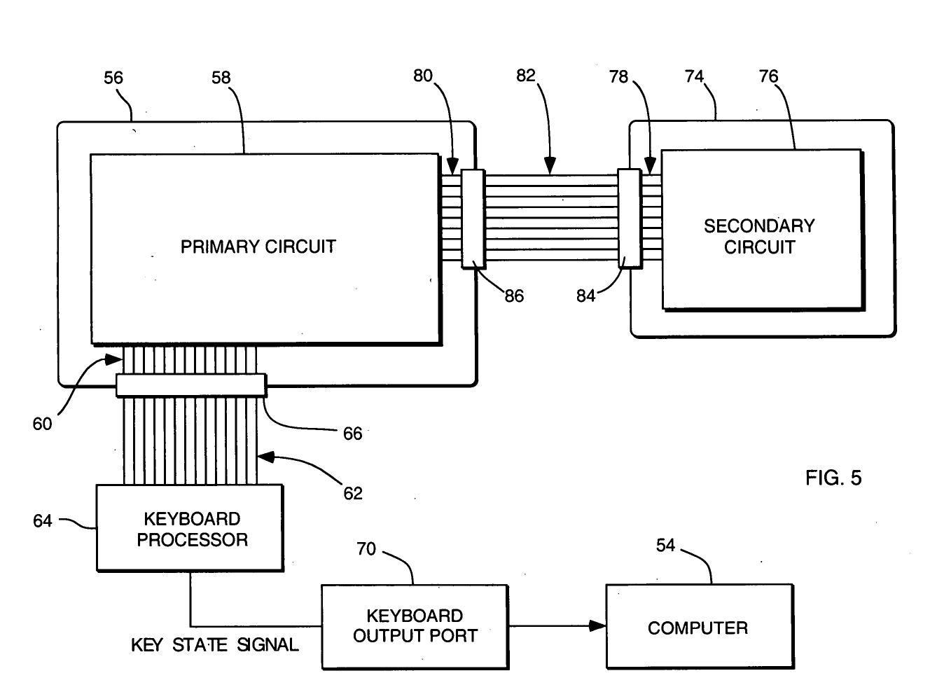

Certain keys have been grouped and positioned on the keyboard 12 to reduce total space and length requirements. As is conventional, the keyboard 12 includes twelve function keys grouped in three sets S1, S2, S3 of four keys and collectively oriented in a straight line, above the alphanumeric keys and inset from an upper lengthwise edge 52 of the keyboard 12. Four of the function keys S3 (labeled “F9” through “F12”) are detailed in FIG. 2; others shown in FIG. 1 are not labeled. The function actually performed by each of the function keys is determined by each software application operating on the associated computer 54 (diagrammatically indicated in FIG. 5). A set S4 of document navigation keys labeled “Home”, “End”, “Page Up” and “Page Down” are grouped together with “Insert” and “Delete” keys, and positioned between the mouse pad 22 and the upper lengthwise edge 52 of the keyboard 12. A set S5 of four arrow keys (shown labeled in FIG. 2) is arranged in a distinct group between the mouse pad 22 and the upper edge 52 of the keyboard 12, laterally offset from the set S4 of document navigation keys. These are often useful in connection with word processing applications that allow movement of a cursor between lines or from character-to-character in response to arrow keys. Still another set S6 of three keys (“Print Screen”, “Scroll Lock” and “Pause/Break”) are located in a group between the function keys S1, S2, S3 and the upper lengthwise edge 52 of the keyboard 12 offset laterally to an opposite side of the page navigation keys. This strategic placement of key sets S4, S5, S6 reduces lateral size requirements for the keyboard device 10, permitting more space to be dedicated to the mouse rolling or sliding surface 24 and the subjacent numeric keypad 14.

FIG. 5 diagrammatically illustrates the components used to detect pressing of keys on either the alphanumeric keyboard 12 or the numeric keypad 14. The keyboard 12 contains a primary circuit board 56 used to detect the state of its keys 18. The primary circuit board 56 may consist of a reinforcing plate supporting a flexible film on which conductor traces have been deposited to define the required primary circuit 58. When a key is depressed, a pathway in the primary circuit 58 is closed thereby indicating pressing of the key. A set of parallel conductor traces 60 at one edge of the circuit board, and a conventional ribbon connector or cable 62 couples a microprocessor 64 to the various circuit paths and permits the processor to detect which paths are open or closed. This electrical connection may involve a connector 66 that contacts each of the conductor traces 60 and couples each of the contacted conductors through a separate conductive path in the ribbon connector 62 to an input terminal of the microprocessor 64. The microprocessor 64 transforms the detected key state into a coded signal that is transmitted from a keyboard port 70 to the associated computer 54. This process is conventional and will not be described in greater detail.

The numeric keypad 14 is associated with a secondary circuit board 74 similar in overall construction to the primary circuit board 56 in the alphanumeric keyboard 12. When keys in the numeric keypad 14 are operated, paths in the secondary circuit 76 are opened and closed as in the prior art. The keypad circuit 76 is associated with a set of parallel electrical conductor traces 78 adjacent one edge of the keypad circuit board 74, and the keyboard circuit 58 has a similar set of conductor traces 80 proximate an adjacent edge of the primary circuit board 56. The two sets 78, 80 of conductor traces on the adjacent board edges are coupled by a ribbon cable 82 and two conventional end-connectors 84, 86. The end-connectors 84, 86 simply place a different one of the conductors in one set of conductive traces 78 in electrical contact with a corresponding one of the conductors in the other set of conductive traces 80. The result is that the open or closed states of the conductive paths in the secondary keypad circuit 76 are made available within the keyboard 12 and ultimately available to the keyboard microprocessor 64.

The primary and secondary circuits 58, 76 may simply be viewed as corresponding to the one circuit normally found in a conventional prior art keyboard. That circuit is effectively divided into two parts to allow the secondary circuit 76 to move with the numeric keypad 14 in order to respond to the pressing of the keys 36 associated with the numeric keypad 14. The parallel conductor traces 78, 80 and the ribbon cable 82 effectively permits the two circuit boards 56, 74 to function as a single board for purposes of operation of the keyboard microprocessor 64, and the length of the ribbon cable 82 is simply selected to accommodate the range of travel of the numeric keypad 14 between its stored and operative orientations.

It will be appreciated that a particular embodiment of the invention has been described and that modifications may be made therein without departing from the spirit of the invention or the scope of the appended claims.

I claim:

1. A keyboard-type device useable with a computer and computer mouse, the device comprising:
an alphanumeric keyboard;
a numeric keypad;
the alphanumeric keyboard comprising an output port, a first multiplicity of keys, a first circuit cooperating with the first multiplicity of keys to produce a first key state signal identifying which, if any, of the first multiplicity of keys are pressed, and structure defining a horizontal platform on which the mouse can operate and defining a storage compartment below the platform dimensioned to store the numeric keypad;
the numeric keypad comprising a second multiplicity of keys and a second circuit cooperating with the second multiplicity of keys to produce a second key state signal identifying which, if any, of the second multiplicity of keys are pressed;
mounting means mounting the numeric keypad to the alphanumeric keyboard for movement between a storage position within the storage compartment and an operative position external to the keyboard in which the second multiplicity of keys can be pressed;
electrical connector means coupling the alphanumeric keyboard and the numeric keypad such that the second key state signal is available within the alphanumeric keyboard, the electrical connector means having sufficient length to accommodate movement of the numeric keypad between the storage position and the operative position; and,
processor means responsive to the first and second key state signals for producing a master key state signal identifying which keys of both the alphanumeric keyboard and the numeric keypad are currently pressed and for transmitting the master key state signal via the output port to the computer.

2. The device of claim 1 in which:
the first multiplicity of keys includes a set of keys labelled as function keys, a set of keys labelled as document navigation keys, and a set of keys labelled as arrow keys;
the alphanumeric keyboard comprises a casing defining an upper surface through which the first multiplicity of keys protrude, the casing comprising a lower lengthwise edge normally proximate to a user and an opposing upper lengthwise edge;
the set of function keys is oriented in a straight line inset from the upper lengthwise edge of the casing;
the set of document navigation keys is oriented in a distinct group between the mouse platform and the upper lengthwise edge of the casing; and,
the set of arrow keys is oriented in a distinct group between the mouse platform and the upper lengthwise edge of the casing and laterally offset from the set of document navigation keys.

3. The device of claim 1 in which:
the storage compartment is located adjacent to one lateral edge of the alphanumeric keyboard; and,
the mounting means constrain sliding movement of the numeric keypad between the storage position and the operative position.

4. The device of claim 3 in which:
the first circuit board comprises a first set of conductors grouped adjacent to one edge of the first circuit board;
the second circuit board comprises a second set of conductors grouped adjacent to one edge of the second circuit board and coupled to the rest of the second circuit board such that any key state signal generated by the numeric keypad is available at the second set of conductors; and,
the electrical connector means comprises a cable with a multiplicity of electrically separate conductors each of which has one end electrically contacted with a different one of the first set of conductors of the first circuit board and an opposite end electrically contacted with a different one of the second set of conductors of the numeric keypad whereby any key state signal generated by the numeric keypad is available at the first set of conductors of the first circuit board.

5. The device of claim 4 in which:
the first set of conductors are conductive traces formed on a film substrate comprised by the first circuit board; and,
the second set of conductors are conductive traces formed on a film substrate comprised by the second circuit board; and,
the electrical connector means comprise a first connector shaped to locate about the one edge of the first circuit board and separately contact each of the conductive traces constituting the first set of conductors, and comprise a second connector shaped to locate about the one edge of the second circuit board and separately contact each of the conductive traces constituting the second set of conductors.

6. A keyboard-type device for use with a computer and computer mouse, comprising:
an alphanumeric keyboard;
a numeric keypad moveable relative to the keyboard;
the alphanumeric keyboard comprising:
(a) a first casing with an upper surface;
(b) a first multiplicity of keys protruding from the upper surface of the first casing;
(c) a first circuit board mounted in the first casing and cooperating with the first multiplicity of keys to indicate which, if any, of the first multiplicity of keys are pressed;
(d) an output port for transmitting a key state signal from the device;
(e) a processor coupled to the first circuit board and to the output port;
(f) structure defining a platform on which the mouse can operate smoothly and defining a storage compartment beneath the platform dimensioned to store the numeric keypad; and,
the numeric keypad comprising:
(g) a second casing with an upper surface;
(h) a second multiplicity of keys protruding from the upper surface of the second casing; and,
(i) a second circuit board mounted in the second casing and cooperating with the keys of the numeric keypad to indicate which, if any, of the keys of the numeric keypad are pressed;
electrical connection means coupling the first and second circuit boards to indicate within the alphanumeric keyboard which keys, if any, of the numeric keypad are pressed, the processor responding to the key states indicated by the first and second circuit boards to produce a corresponding master key state signal at the output port indicating which keys, if any, of both the alphanumeric keyboard and the numeric keypad are pressed.

7. The device of claim 6 comprising means mounting the numeric keypad to the alphanumeric keyboard for sliding displacement along a predetermined axis between the storage position and the operative position.

8. The device of claim 7 comprising stop means preventing displacement of the numeric keypad beyond its operative position relative to the keyboard.

9. The device of claim 6 in which:
the first circuit board comprises a first set of conductors grouped adjacent to one edge of the first circuit board;
the second circuit board comprises a second set of conductors grouped adjacent to one edge of the second circuit board and coupled to the rest of the second circuit board such that any key state signal generated by the numeric keypad is available at the second set of conductors; and,
the electrical connector means comprises a cable with a multiplicity of electrically separate conductors each of which has one end electrically contacted with a different one of the first set of conductors of the first circuit board and an opposite end electrically contacted with a different one of the second set of conductors of the numeric keypad whereby any key state signal generated by the numeric keypad is available at the first set of conductors of the first circuit board.

10. The device of claim 9 in which:
the first set of conductors are conductive traces formed on a film substrate comprised by the first circuit board; and,
the second set of conductors are conductive traces formed on a film substrate comprised by the second circuit board; and,
the electrical connector means comprise a first connector shaped to locate about the one edge of the first circuit board and separately contact each of the conductive traces constituting the first set of conductors, and comprise a second connector shaped to locate about the one edge of the second circuit board and separately contact each of the conductive traces constituting the second set of conductors.
